(19) United States
(12) Patent Application Publication
(10) Pub. No.: US 2008/0123682 A1
(43) Pub. Date: May 29, 2008

(54) Method for scheduling transmissions in an ad hoc network

(76) Inventors: Justin Michael Yackoski, Newark, DE (US); Chien-Chung Shen, Newark, DE (US)

Correspondence Address: POTTER ANDERSON & CORROON LLP;ATTN: KATHLEEN W. GEIGER, ESQ., P.O. BOX 951, WILMINGTON, DE, 19899-0951, US

(21) Appl. No.: 11/823,024

(22) Filed: Jun. 26, 2007

Related U.S. Application Data
(60) Provisional application No. 60/816,899, filed on Jun. 27, 2006.

(51) Int. Cl. H04B 7/212

(52) U.S. Cl. 370/443

(57) ABSTRACT

This invention relates to a method for scheduling and synchronizing all transmissions of data in an ad hoc network. Data is transmitted on a given path from a given source of the data to a given destination. Time is divided into cycles and in each cycle each node in the path transmits data belonging to the path during the same time slot reserved for that node and path. Time slots have arbitrary sizes, are reserved via trial and error, and the time slot schedule is iteratively optimized to reduce end-to-end delay using local coordination rules between nodes. The scheduling method can be used for wireless, wired, acoustic or optical networks.

### CROSS-REFERENCE TO RELATED APPLICATION

This application claims the benefit of U.S. Provisional Application No. 60/816,899, filed on Jun. 27, 2006, which is incorporated in its entirety as a part hereof for all purposes.

### FIELD OF THE INVENTION

This invention relates to a method for scheduling and synchronizing all transmissions in an ad hoc network.

### BACKGROUND OF THE INVENTION

In current multi-hop wireless and wired networks, nodes operate independently and maintain very little, if any, information about the state of themselves and of other nodes in the network. Nodes generally do not coordinate their transmission schedules with the rest of the network. For example, in a contention-based protocol like IEEE 802.11 DCF, when two neighboring nodes generate a data packet at approximately the same time and they wish to transmit that data packet to a third node these two nodes will contend for the right to do so. One of the nodes will eventually win and transmit first, followed by the other node. Random backoffs are commonly used on a per-packet basis to resolve contention. This simple method promotes the distributed nature of today's networks. However, the constant use of contention places a burden on the network, resulting in higher end-to-end delay, more packet loss, and lower energy efficiency.

Streaming voice, video, and data are increasingly common and streaming traffic often is generated at very regular intervals. Therefore, if two nodes generate contending data packets at approximately the same time, subsequent data packets will also be generated at approximately the same time, requiring both nodes to endlessly contend for the channel. If the outcome of the previous contention was desirable to all parties, the nodes could simply agree to reuse the previously agreed upon schedule instead of re-contending, wasting time, energy, and bandwidth, and introducing more jitter. As bandwidth increases, the delay becomes especially critical in keeping the bandwidth-delay product at a manageable level.

Various alternatives have been proposed to improve performance. One of these uses explicit reservations similar to IEEE 802.11 's Request-To-Send (RTS) frames to reserve a segment of the source-destination path for relatively short periods at a time and only up to an intersection with another path (Ramanathan, R., Proceedings of the 11th Annual international Conference on Mobile Computing and Networking, Cologne, Germany, Aug. 28-Sep. 2, 2005, MobiCom '05. ACM Press, New York, N.Y., p. 132-139 (2005)). Multiple hops and multiple data packets may be forwarded within the segment, when data is transmitted to one of these intersection points, the next segment of the path must be separately reserved when it becomes available. As the number of paths and thus the number of intersection points increase, this mechanism degrades to single-hop reservation. More intelligent single-hop back off or time division multiple access (TDMA) strategies have been proposed but multi-hop coordination is not addressed, resulting in high end-to-end delays. A global synchronization of time has also been proposed. Path reservation on the other hand requires an agreement on the scheduled use at intersection points. Even when node clocks are synchronized, distributed detection and scheduling of intersection points remains an open and complex problem.

The primary challenge currently preventing multi-hop ad hoc networks from offering satisfactory performance is not the scheduling of time slots solely to avoid contention between nodes, instead it is the scheduling of time slots to reduce or eliminate the delay penalty incurred by current protocols at each hop in a path. As long as a data packet sent along a multi-hop path experiences a random per-packet contention delay to first acquire the channel or a fixed per-packet scheduling delay due to a rigid or naïve TDMA time slot assignment, ad hoc network performance will not be tolerable beyond a few hops.

Thus, there is a need for a method for full-path, long life scheduling of data transmissions so that all transmissions of data are synchronized in a path-aware manner.

### SUMMARY OF THE INVENTION

This invention provides a method for scheduling all transmissions in an ad hoc network containing multiple nodes and multiple data flows, comprising transmitting data on a given path of nodes from a given source of the data to a given destination of the data, wherein all transmissions of data in the network are synchronized.

In one embodiment, time is divided into cycles and the cycle size of all nodes in the network is the same. Each node in a given path has at least one reserved time slot within the cycle for transmission of data belonging to the given path and all transmissions of data belonging to the given path by a node in the given path are scheduled to occur during the same at least one reserved time slot of that node in each cycle.

In another embodiment, the method for scheduling all transmissions in an ad hoc network containing multiple nodes, comprises the steps of:
(a) dividing time into cycles and setting the cycle time of all the nodes in the network to the same size;
(b) having the nodes agree upon the start of the cycle;
(c) establishing a path of nodes from a given source of the data to a given destination of the data; and
(d) determining via trial and error at least one reserved time slot within the cycle for each node in the path to transmit data belonging to the path and optimizing the reserved time slots in a distributed fashion to reduce the end-to-end delay experienced by each path,
   wherein in each cycle, each node in the path is scheduled to transmit data belonging to the path during the same at least one reserved time slot of that node.

Preferably, in step (d) it is assumed that if a given time slot is busy, the previous and subsequent time slots are also busy and the time slots to transmit data are determined accordingly.

### BRIEF DESCRIPTION OF THE FIGURES

FIG. 1 shows the static 4×4 network of nodes and the two paths used in the Example and Comparison.

FIG. 2 shows the end-to-end delays experienced in the Example and in the Comparison.

### DETAILED DESCRIPTION OF THE PREFERRED EMBODIMENTS

The instant invention provides a method for scheduling all transmissions in an ad hoc network and can be used for wireless, wired, acoustic, or optical networks.

For convenience, the invention will be described primarily as applied to a wireless mesh network with omnidirectional antennas, two-way communication, and generally stable links carrying streaming data flows which generate packets at regular intervals. The adjustments needed for the invention to function under the additional constraint of high and/or uncertain propagation delays, such as in an acoustic environment, will also be described. As indicated previously, the invention is applicable to a variety of ad hoc networks and to a variety of conditions within those networks.

As used herein, “source” refers to a node that is the global source of a path or flow of data. “Sender” refers to a node that is the sender of a given medium access control (MAC) layer frame. “Receiver” refers to a node that is the receiver of a given MAC layer frame. “Destination” refers to a node that is the final destination of a path or flow of data. “Offset” is the time interval between the beginning of a cycle and the beginning of a time slot reserved by that node. A “time slot”, or “slot”, is a portion of the cycle reserved by a node to use to transmit data.

Coordination and synchronization of all nodes in a network is obtained by splitting time into cycles and setting the cycle times of all the nodes in the network to the same size. Using a cyclic coordination mechanism, nodes coordinate to schedule their behavior, e.g., the transmission of data, relative to the start of the cycle. They resolve contention by scheduling the exact time of their transmissions using distributed coordination instead of the traditionally used random backoff. Once the schedule for the cycle is determined, the same schedule is re-used for all cycles. In each subsequent cycle, the schedule is followed and nodes can operate under the assumption that all other nodes will adhere to the schedule. The procedure involving control messages and contention to determine a schedule is needed only during the initial network self-configuration or when nodes must change their schedule due to significant changes in application demands or network conditions.

The method of the invention is a significant departure from current network protocols, especially common MAC layer protocols such as 802.11 DCF and Ethernet which rely on random backoffs and contention to acquire the use of the shared medium for every frame sent. This method also differs from centralized TDMA-based protocols which assign fixed time slots to each node without regard for the multi-hop nature of paths or the end-to-end delay they experience. In the method of the invention the schedule is determined in a multi-hop, path-aware way with each node independently using typical distributed mechanisms such as those used by IEEE 802.11 DCF and Ethernet to acquire the right to perform certain activities during a portion of the cycle.

Time is divided into cycles of an agreed upon size, and each node may reserve and own one or more time slots, i.e., portions of the cycle of arbitrary size and offset, to use to transmit data. Each node in a given path reserves at least one time slot within the cycle to transmit data belonging to the path.

The cycle size is set to a size deemed appropriate for the anticipated network conditions and will be kept constant. However, under high load or poor channel conditions the cycle size is temporarily increased. Nodes agree upon the start of the cycle relative to the current time by transmitting the sender's current believed cycle offset, along with the cycle time and the sender's identification (ID), in the header of all packets. When a node observes another node's transmission with an offset significantly different than its own, the node adjusts the start of the subsequent cycle, and thus temporarily adjusts its cycle size, to match the observed offset at the start of the next cycle. Since exact synchronization of time is not achievable, nodes use the advertised offset in packet headers to normalize any other offsets in the packet to its perception of time. Tight clock synchronization is not needed, since each packet header contains what the sender believes to be the current cycle offset. This value can be compared to the receiver's believed offset, and the difference used to correct any difference in the start of a cycle for the two nodes assuming the propagation delay can be precisely determined, or is negligible as is the case in many RF-based wireless ad hoc networks.

When a path is first used, a Path Request-To-Send (PRTS) frame is sent from the source to the destination, traveling the entire length of the path. The PRTS includes the frequency and duration of data frames which will be sent along the path to ensure sufficient capacity exists, a source route to the destination, the Path ID, i.e., the combination of the source ID and destination ID, the number of hops in the path, and the next hop index, the index of the next hop in the source route which should process the PRTS. Upon receiving a PRTS for a given Path ID, intermediate nodes check whether the entry in the source route at the current next node index matches their ID. If so, the node stores its node index, and will later forward any data frames with the same node index and Path ID. Before forwarding to the next hop, the node must only increment the next node index, and does not otherwise change the packet or specify the next hop as in traditional routing protocols. This allows forwarding decisions to be made quickly at the MAC layer.

When the PRTS reaches the destination by following the source route, a Path Clear-To-Send (PCTS) frame is sent back to the destination. The PCTS contains the path ID, the allowed frequency and duration of frames the source may send, the highest cycle size seen along the path, and the next node index. The cycle size should be the uniform cycle size of all nodes unless one or more nodes has temporarily increased its cycle time as a result of high load. A higher cycle size is a measure of congestion. When a node receives a PCTS, the node checks whether it is a part of the given path and ensures its node index for that path matches the next node index. If so, the node only decrements the next node index and forwards the PCTS. While the PRTS is still in transit, the source can start sending data along the path to reduce the initial delay. However, as the path is not fully established and end-to-end congestion information is not known, the data rate is limited to one frame per cycle to avoid buffer overflows and lost frames. Once the PCTS is received, the data can be transmitted at the rate given in the PCTS. This allows for the initial data, which often establishes the connection at both the transport and application layers, to avoid a one round-trip-time delay.

Transmissions are scheduled and synchronized such that all transmissions on a given path occur at the exact same time in each cycle. A given node transmits data to the next hop node on a given path during the same time slot, i.e., the time slot reserved for that transmission by that node, in every cycle. Unlike traditional time slots, these time slots are variable in size and may begin at any offset from the start of the cycle. A given time slot is reserved and owned by a node to transmit data from a specific source to a specific destination via a specific next hop node. A time slot becomes reserved and owned by a node through trial and error, and the owning node maintains its ownership through neighboring nodes observing its continued use of the slot. The trial and error consists of the node attempting to win a time slot starting at a given offset with a given size time slot to send to the next hop in that time slot. If the next hop acknowledges the transmission was successful, the node has reserved and obtained ownership of that time slot. If unsuccessful, the node tries again with a different offset and repeats the process until successful. Nodes attempt to reserve and own slots so that packets can be sent as soon as possible after they are received either by the application or by a previous hop. If a node tries to use a potential new slot and receives an acknowledgment that the attempt was successful, the slot is considered reserved and owned by that node. By expending the effort to reserve and own a certain slot, the node is then reasonably guaranteed that the slot can be used to transmit in all future cycles without the need to re-contend for the channel since other nodes will yield to it.

The channel is monitored and times during which it is busy are recorded as they are observed. A node can observe the channel is busy either by successfully decoding a transmitted packet, or by “carrier sensing”, i.e., detecting that a transmission has occurred but failing to decode the transmitted packet. If a carrier sensed time slot is observed, only existing empty or carrier sensed time slots are updated, and time slots recorded as a result of successfully decoded packets are left unchanged.

In a preferred embodiment, when a time slot is observed to be busy i.e., when node B is observed to be transmitting along route A to B to C to D, a time slot of equal size is also assumed to be busy both immediately before and immediately after node B's observed transmission. This is to allow for node A's previous and node C's subsequent relaying of the same data packet. This assumption is ignored when the next hop is the destination node and when the current hop is the source, since there will then be no subsequent or prior transmission, respectively. This assumption is also modified in the case that a data packet is received and the sender explicitly specified in the header fields when the sender received the data from its previous hop. In this case the receiver node or the overhearing node marks the slot specified by the sender as busy instead of the slot immediately before the slot the packet was heard in. In another case, if known transmission occurs partially or fully overlapping the slot to be presumed busy, only the portion of the cycle which is currently free is presumed busy. In cases where in path . . . to A to B to C . . . the transmissions of node A are carrier sensed by node C, the node 2 hops upstream to the current transmitting node A, node C assumes the slot after the carrier sensed transmission is busy and prevents node B from using the slot by reporting the slot to node B as unusable. Although node B is the node which should in most cases be using the slot, node C cannot determine this directly since node C cannot decode node A's transmissions. To address this, each node randomly adjusts its transmission time by a very short time, i.e., a few microseconds before or after its scheduled transmission time. The amount of the adjustment, along with A's transmit offset, are provided by node A to node B, which in turn provides it to node C via frame headers. Node C checks whether any transmissions carrier sensed at A's transmit time have moved by A's adjustment amount, and if so, node C does not assume the subsequent slot to be busy, allowing B to use it.

To ensure proper reception, it is necessary for the medium to be free both at the sending node to avoid interfering with other transmissions and the receiving node to avoid interference from other transmissions. Instead of a typical Request-To-Send/Clear-To-Send (RTS/CTS) mechanism, consecutive nodes in a path exchange information about free periods. Initially, a random backoff is blindly used when the node currently holding a data frame first communicates with the next hop in the path. In this initial transmission, the current node includes the desired offset, the earliest time in the cycle after receiving the data that the current node believes to be available for the transmission. When the next hop then forwards the data to the next-next hop, the next hop node either indicates that the current node's desired offset is suitable or specifies a later offset as the earliest available offset which the current node will obey when choosing new slots. The time slots are thus optimized in a distributed fashion, i.e., the nodes operate with only local information and do not have a central authority to direct them. For example, if each node in a path obtains a time slot which reduces the delay between when it gets a message and when it sends it, the nodes have optimized the time slots and the end-to-end delay in a distributed way.

To accommodate the transmission schedules at each hop in a path, intermediate nodes must buffer data frames temporarily until their next scheduled transmission time. Overhearing the relaying of data is relied on as an implicit acknowledgment (IACK), so nodes must also buffer data frames for a short time after transmission until an acknowledgment is heard. Although MAC protocols do not typically buffer multiple packets, this is necessary in order to flexibly schedule transmissions when paths cross and to prevent loss near the destination from incurring the high delay of re-sending data from the source. The buffer space needed at each node will be typically be small, i.e., at most two packets per flow through the node.

Since a node may make multiple attempts to transmit the same data packet, potentially attempting to use several new slots, the IACK information must include the offset when the data was received. This allows the node receiving the IACK to determine which of the node's possibly several slots was used successfully.

In some situations, the traffic level or channel quality may result in nodes receiving more data frames than they are able to relay and receive acknowledgments for. Without congestion control the buffers of these nodes may overflow, requiring the source to retransmit the data. To address temporary congestion, each intermediate node may only relay a limited number of data packets for a path without receiving an acknowledgment. Once this limit is reached, the node temporarily stops relaying new data packets, which in turn causes its previous hop in the path to stop receiving IACKs. This process continues until the source must temporarily stop sending new packets. To address more permanent congestion, the intermediate nodes and destination propagate the highest cycle size, highest cumulative explicit acknowledgement (EACK), and other congestion information back to the sender one hop at a time by including them on transmitted data frames. The source then adjusts its average sending rate accordingly.

To address cases where an expected data packet is not received, nodes may set a negative acknowledgment (NACK) header field to indicate to the sender that a retransmission is required. This allows the sender to retransmit more rapidly, reducing the impact of such missing packets.

In a preferred embodiment, when a node notices that transmissions in an owned slot are no longer received successfully, the node assumes some other nearby sender has started transmitting in an unintentionally overlapping slot. The node may protect the older, owned slot by notifying the unidentified sender of the conflict. The node does so by setting a header field in all transmissions sent for the next several cycles. The field indicates the approximate offset of the offending transmission. Neighboring nodes that overhear a transmission with such a field in turn propagate the information among their neighbors, allowing the notice to spread outward to the areas where the offending node may be located. When the notice reaches the offending sender, the offset is checked against the offset of any slots that the offending sender has recently started using. Any overlapping slots are then removed from use to allow the owner to regain use of the owned slot.

To improve a path's ability to quickly reduce its end-to-end delay, time slots reserved and owned by a particular node are allowed to be commandeered and used by other members of the path. Consider nodes A and B on a portion of a path, where node A forwards data to node B at slot t₂ after which node B re-forwards the data to the next hop node C at time slot t₃. If in a later cycle node A successfully contends for and uses earlier time slot t₁ to transmit to B, time slot t₂ goes unused for several cycles as surrounding nodes assume node A is still using it. Since node B knows node A successfully used slot t₁ and therefore will not be using t₂, node B can immediately begin using slot t₂ provided node C's channel is not busy at that time.

The method of transmission scheduling of the invention improves the regularity and predictability of transmissions, which allows other network components to better optimize their behavior to better meet quality-of-service (QoS) constraints, operate more efficiently, and provide a more stable experience to the user. The Ramananthan reference cited above likens the hop-centric operations to a subway train system that has passengers get off at every intermediate station enroute to their destination, go outside the station, get in line for a fresh ticket, wait all over again for the next train and board it. The method of transmission scheduling of the invention is akin to an express train that moves passengers from source to destination without incurring delay at intermediate hops.

In a preferred embodiment, each destination node receives QoS feedback, specifically notice of whether the end-to-end delay being provided by the current transmission schedule meets the QoS demands of the application. The destination node and intermediate nodes then propagate this information backward along the path as part of the acknowledgment information that is usually sent. When an intermediate node receives notice that the end-to-end delay is satisfactory, the information is given to its previous hop without delay. When an intermediate node receives notice that the end-to-end delay is too long, the node first attempts to reduce the delay by obtaining a new, earlier slot. The node waits two or more cycles and then notifies its previous hop that the end-to-end delay is too long This allows nodes near the destination the first opportunity to lower the end-to-end delay, and avoids the costs of all nodes in a path always attempting to obtain new slots whenever the end-to-end delay is too long. In addition, the first time intermediate nodes become aware that the end-to-end delay is satisfactory, each node records the offset of its slot(s) for that path. If an intermediate node later notices that the current slot it is using is significantly later than the recorded offset, the node assumes the end-to-end delay is now likely too long and so makes several attempts to acquire an earlier slot. This pre-emptive action occurs independent of the node's known status of the end-to-end delay.

The method facilitates cooperative relaying in which nodes transmit the same information nearly concurrently to reduce the signal-to-noise (SNR) ratio. Using improved coordination, nodes may better stagger cooperative transmissions to reduce the chance that a burst of noise will disrupt all transmissions, and nodes can better decide when all cooperative transmissions have been received since their transmission times are known.

Even with perfect scheduling, in a congested network nodes may need to wait relatively long, e.g., tens of milliseconds, to transmit data. The unique understanding of the network conditions with the scheduling method of the invention with respect to time allows higher layers to delay creating data until just before it is sent, giving real-time applications the ability to send more up-to-date data, effectively reducing the end-to-end delay experienced. For streaming applications, the method can recommend to the encoding application how and when to packetize data to minimize the end-to-end delay.

Various features can be added to or adjusted within the method for scheduling to provide specific features and adaptation to for specific uses.

For example, the method can be used to provide admission control, only allowing new paths when sufficient channel capacity exists to allow both existing paths and the potential new path(s) to transmit at their desired rate. The unique design of the method can allow for delay-based admission control based on the source application layer's desired transmit times, in addition to the bandwidth-based admission control typically used in networks.

Alternatively, when insufficient channel capacity exists, the method can assign time slots based on priority where high priority paths receive more slots, or based on fairness where all paths receive approximately the same level of performance relative to their desired performance.

The PRTS can be used in conjunction with initial local coordination to setup initial slots while the path is established, in order to reduce the time needed for the path to converge to the optimal value. PRTS-like packets may also be sent along the path periodically to inform the source/destination of the quality of service or request changes to the path performance, such as better delay or more bandwidth.

The method can be paired with the route discovery process and multiple PRTS packets can be sent along different routes. The source and/or destination may then select the path with the most desirable conditions based on the source's desired transmission times and quality of service constraints.

The method's unique knowledge of channel congestion relative to time can be used to allow it to communicate with the application layer to suggest the best times for the application layer to create new packets so that they experience minimal end-to-end delay.

To handle bursty traffic or a mix or streaming and non-streaming data, the method can schedule the average or minimum traffic rate needed by a path, and require any additional traffic above this rate to contend for the channel on a per-packet basis.

Alternatively, to handle bursty traffic and/or reduce the schedule size, only “backbone” nodes may use the method of the invention for scheduling and other nodes use a traditional contention protocol like IEEE 802.11. Within the backbone, the method can treat the backbone nodes nearest the actual source/destination as the path endpoints, allowing the traffic to be aggregated into a more stable and predictable flow. In addition, time slots of sufficient size can be reserved so that multiple packets can be transmitted.

To reduce contention needed for streaming flows to win their desired N time slots per cycle, the first 1/Nth of the cycle can be designated special such that if a node wins and reserves a time slot with an offset K during this first 1/Nth of the cycle, the node then by default reserves and owns additional time slots at offsets K+1/N, K+2/N, etc., up to K+(N−1)/N.

Local and/or global optimization algorithms can be used to further refine the time slot schedule after it has been fully or partially established. These can be used to improve performance, e.g., to reduce wasted time, to improve channel re-use and improve end-to-end delay, etc. For example, these may be used to detect and handle the “exposed terminal problem”, a well-known wireless networking problem.

Each node can keep a taboo list of slots that the node has attempted to use unsuccessfully one or more times. The node keeps record of such failed attempts in the taboo list and then avoids re-attempting to use these slots, which may be more likely to result in failure in the future than other, untested slots.

For sensor networks and data fusion applications, the method of the invention can be adapted to schedule transmissions in such a way that two related pieces of data sent from different sources arrive at their destination at the same time, reducing the destination's buffering and processing demands.

For multicast applications, where data is sent from a single source to multiple destinations, or vice versa in sensor network applications, the method can be adapted to allow nodes at branching points in the multicast tree to coordinate their transmissions.

When dealing with mobile nodes, the SNR can be used to detect when a time slot begins to become unusable due to node movement. In one adaptation, time slots would be assigned to send to and from certain geographical areas, instead of to/from certain nodes.

In a single-hop environment where all nodes are within transmission or interference range of each other and all paths are 1-2 hops long, assumptions made by the method of scheduling to compensate for multi-hop paths can be relaxed to allow more efficient operations.

The method for scheduling can be applied to other domains where access to a shared resource must be scheduled. One such application is in domains where intersection points such as routers in a wired or optical network may only be used by one transmission at a time.

In acoustic networks, additional features are required for the trial-and-error slot scheduling mechanism to compensate for the propagation delays, which are several orders of magnitude larger than in similar RF networks, can not be accurately estimated, and may change due to fluctuations in temperature or other environmental conditions. In the RF networks previously discussed where propagation delays are negligible, some sender A (with data to send to receiver A) overhearing another transmission by another sender B (with data to send to receiver B) can accurately determine both when this transmission by sender B will be received by receiver A and when a transmission by sender A during an adjacent slot will be received by receiver A. This information allows sender A to attempt to acquire only slots which have a high likelihood of being usable and, more importantly, of not conflicting with the owned slots of other nodes.

In acoustic networks, sender A is not able to determine when a transmission in sender B's owned slot and a transmission in the potential new slot under consideration by sender A will reach receivers A and B, due to the nature of the propagation delays. The resulting high risk of interfering with owned slots prevents the invention's trial-and-error scheduling method from being used while actual data transmissions are taking place. To address such environments the cycle is divided into two sections: an established section where only approved transmissions may occur, and an experimental section where new transmissions may be attempted.

Since time synchronization more precise than the amount of variation in propagation delay between nodes is difficult in acoustic networks, the boundaries between the two sections of the cycle are surrounded by guard times equal to the largest expected time synchronization error, e.g. the largest possible propagation delay between nearby nodes.

When some node X requires a new slot, the following process is used instead of that previously described for general wireless networks. Node X selects a random time within the experimental section of the cycle and transmits a packet containing both data and control information. Node X includes in this packet a delta value indicating the difference in time between when the packet is transmitted in the experimental section of the cycle and when node X would like to transmit the packet in the established section. By performing an actual transmission and indicating only the delta between the time the request packet was sent and the slot being requested, each neighboring node is able to determine precisely when they will received the requested transmission in relation to owned slots, without requiring any measurement of the propagation delay between nodes. Since the request occurs during the experimental section of the cycle, the danger of interfering with an owned slot is avoided.

Each node which hears X's request checks their record of owned slots to determine whether the proposed transmission in the established section of the cycle would interfere with their reception during any owned slots. Nodes respond to X's request by piggy-backing information on a transmission during one of their owned slots or, if needed, by sending a separate control frame in the experimental portion of the cycle. Each node may produce one of the following responses:

(a) Approved—the request is approved as the responding node believes the new slot is sufficiently separated from all other received transmissions such that it will not cause interference. The responding node may also suggest a slightly modified delta for node X to request which reduces the gap between the new slot and an established slot in order to reduce fragmentation.

(b) Denied—the request is denied as the responding node believes the new slot will cause interference with an owned slot. The responding node may suggest one or more alternate deltas for node X to request.

(c) Conditionally Approved—the responding node Y believes the new slot may not cause interference but the new slot must be tested first to ensure interference will not occur between X's proposed new slot and an adjacent owned slot during which time node Y or a neighbor of node Y is sending or receiving.

If any response is Denied, node X sends a new request with a delta requesting use of a different slot.

If any response is Conditionally Approved, node X must either request a different slot or, if desired, coordinate a test of the requested slot. To test the slot, node X requests a temporary reservation of a portion of the experimental section of the cycle in which to conduct the test and informs the conditionally approving nodes of the delta between the requested new slot and the test slot. Both node X and conditionally approving nodes then send test transmissions which mimic the relative timing of the established slots and the proposed new slots. Conditionally approving nodes then check whether the test transmission was successful and send node X a new response indicating X's request is either approved or denied.

Otherwise, if all responses are Approved, node X repeats the request at random offsets in the experimental section of the cycle for several additional cycles to ensure all neighboring nodes have heard the request and all responses have been heard. This also allows time for nodes to consult with any two-hop neighbors of node X. If only approved responses are received for several cycles, the node may then transmit during the requested slot in the established section of the cycle and the method of scheduling continues to operate as usual.

### Example of a Preferred Embodiment of the Invention And a Comparison

One embodiment of the method of the invention has been used as an Example to demonstrate the improvement in performance when using the method. The method of the Example synchronizes all transmissions of data in the network. A cycle size is set for all nodes in the network, the nodes agree upon the start of the cycle, establish a path of nodes from a given source of the data to a given destination of the data and determine and optimize time slots for each node in the path to transmit data belonging to the path. In each cycle, each node in the path transmits data belonging to the path during the one or more determined time slots for that node. The assumption that if a given time slot is deemed busy, the previous and subsequent time slots are also busy has been included.

The Comparison has been carried out using the existing IEEE 802.11 protocol in the default configuration. (IEEE Std 8802-11: 1999, IEEE Standards for Information Technology—Telecommunications and Information Exchange between Systems—Local and Metropolitan Area Networks—Specific Requirements—Part 11: Wireless LAN Medium Access Control (MAC) and Physical Layer (PHY) Specifications)

The Example and the Comparison were carried out using the simulation software QualNet® 3.7 (Scalable Network Technologies, Los Angeles, Calif. 90045) with a 2 Mbps wireless channel, no mobility, two-ray path loss, and no fading. The routing protocol used was the Dynamic Source Routing Protocol for Mobile Ad Hoc Networks (DSR) (David B. Johnson et al., DSR: The Dynamic Source Routing Protocol for Multi-Hop Wireless Ad Hoc Networks, Chapter 5 in Ad Hoc Networking, edited by Charles E. Perkins, pp 139-157, Addison-Wesley Professional, Boston, Mass. 02116 (2000)).

A fixed mesh network was assumed so no link errors were reported to DSR, and therefore the initial path route found by DSR is used unchanged for the duration of the simulation.

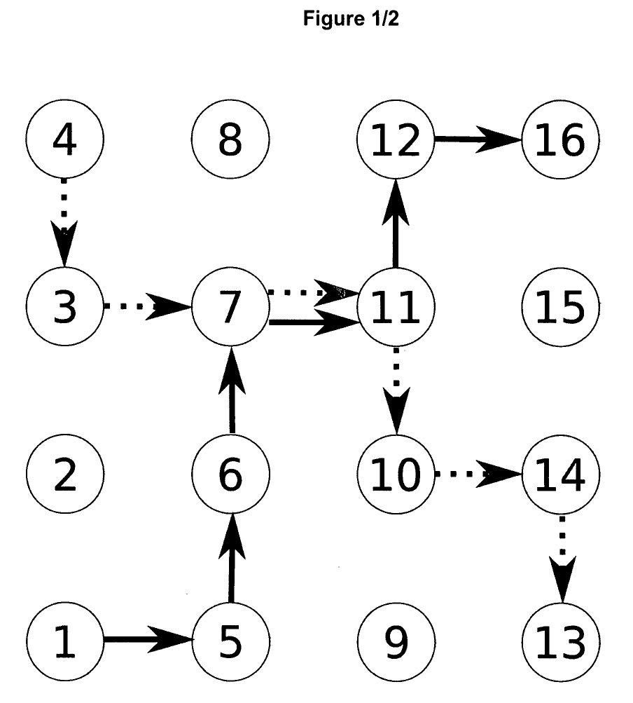

The network chosen consisted of 16 nodes spaced 225 m apart in a static 4×4 grid as shown in FIG. 1. The transmission range was 250 m so that only a node's 4 directly adjacent neighbors had the ability to reliably communicate. Diagonal neighbors, such as nodes 1 and 6, and straight two-hop neighbors, such as nodes 1 and 3, are able to carrier sense each other's transmissions with high reliability. Nodes which are diagonally three hops apart, such as nodes 1 and 7 unreliably carrier sense each other's transmissions. However, a transmission by node 1 will often interfere with node 7's reception of another data packet.

Nodes 1 and 4 generate constant-bit-rate (CBR) traffic destined for nodes 16 and 13, respectively, at a rate of two 512-byte packets per second. Two paths are established, one from node 1 to node 16 which follows the route indicated by the solid arrows FIG. 1, and one from node 4 to node 13 indicated by the dashed arrows.

Of particular importance, nodes 1 and 4 always generate packets at the exact same moment, forcing contention to occur. The topology shown in FIG. 1 was chosen because it contains several complicated interactions which must be addressed. For example, if nodes 1 and 4 both attempt to transmit their packets immediately, node 1 will succeed, however node 4 will generally fail since node 1's transmission interferes with node 3's reception. This must be recognized and addressed by the scheduling method. In addition, if node 5 tries to transmit to node 6 while node 4 is attempting to transmit, both transmissions will sometimes fail but also sometimes succeed, requiring the scheduling method to rule out such schedules even though they sometimes produce lower delays. Various other interactions also exist since the two paths interact over the majority of their length.

For the Example, the cycle size was set at 500 ms, the number of cycles a slot must be unused before it expires is 3, the probability a node will try to move an owned slot slightly forward is ½, the probability a node will try to find a completely new earlier slot is ⅓, and the contention backoff uniformly distributed between 0 and 200 microseconds. Initial cycle offsets are randomly chosen at each node.

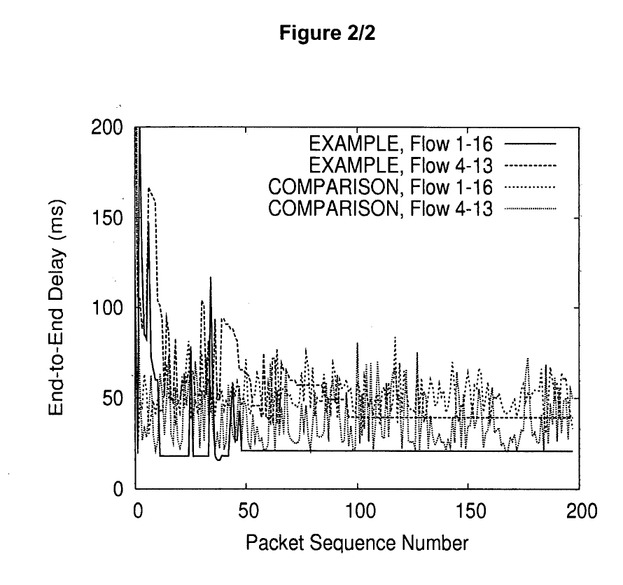

FIG. 2 compares the end-to-end delay experienced by the first 200 CBR packets of the two paths for the Example and the Comparison (802.11). Since each path is 6 hops in length, the optimal end-to-end delay, assuming each hop begins transmitting the instant a packet is fully received, is approximately 15.3 ms. In the basic case where the network has only one 6-hop flow, the method used in the Example is able to converge to an end-to-end delay under 16 ms within the first 10-20 packets. With multiple competing flows, such a short delay is not possible for all flows as some must wait while others transmit.

The end-to-end delay of the Comparison is unstable throughout the simulation. This is expected since a random backoff is used before each transmission. The delay of the Example is initially higher or comparable to that of the Comparison during the first 25-50 seconds (50-100 packets) and converges towards a very stable and low delay. The behavior of the Example is clear from the results shown in FIG. 2. As the method used in the Example learns of faster end-to-end transmission schedules, they are used until a better schedule is found to replace them. Thus, the end-to-end delay of the Example approaches the minimum end-to-end delay observed with the random choices of the Comparison but unlike with the Comparison, once the method of the Example finds a good schedule, the schedule is re-used for the remainder of the path's lifetime.

Table 1 shows the end-to-end time delays for the first one hundred packets and the second one hundred packets. Minimum, maximum and median delays are given for each path. The delays of the Comparison for flow from node 4 to node 13 tend to be lower delay than those of the Example while delays of the Example for flow from node 1 to node 16 tend to be lower than those of the Comparison. However, the converged delay of the Example experienced by flow form node 1 to node 16 is 20.92 ms while the delay of the Comparison for flow from node 4 to node 13 was never below 20.94 ms and only 17% of the packets had a delay below 25 ms. The delays of the Example remain stable below 21 ms for the duration of the flow's lifetime. Similarly, flow from node 4 to node 13 had a Example converged delay of 39.29 ms, while with the Comparison flow from node 1 to node 16 experienced a minimum delay of 21.91 ms but only 9% of packets experienced delays under 40 ms.

These values are significantly affected by the convergence period. After converging, the results of the Example had end-to-end jitter below 10 microseconds, assuming no retransmissions or schedule modifications are necessary. This jitter was by design, each node in the Example intentionally varied its transmission times between −5 microseconds and +5 microseconds of the scheduled transmission time to allow nodes 2-hops downstream to detect time slots which are incorrectly assumed to be busy.

Overall, the method of the Example provides a stable end-to-end delay once the protocol has converged.

TABLE 1
End-to-End Delay Ranges (ms)

| | | COMPARISON | | | EXAMPLE | | |
|---|---|---|---|---|---|---|---|
| Packet Range | Path | Min. | Max. | Median | Min. | Max. | Median |
| 1-100 | 1 to 16 | 21.916 | 114.397 | 49.423 | 15.798 | 206.072 | 20.923 |
| 1-100 | 4 to 13 | 20.959 | 605.707 | 31.190 | 36.383 | 277.484 | 57.088 |
| 101-200 | 1 to 16 | 29.353 | 83.892 | 49.969 | 20.915 | 20.926 | 20.920 |
| 101-200 | 4 to 13 | 20.944 | 80.745 | 32.527 | 39.290 | 39.508 | 39.296 |

What is claimed is:

1. A method for scheduling all transmissions in an ad hoc network containing multiple nodes and multiple data flows, comprising transmitting data on a given path of nodes from a given source of the data to a given destination of the data, wherein all transmissions of data in the network are synchronized.

2. The method of claim 1, wherein time is divided into cycles and the cycle size of all nodes in the network is the same with each node in a given path having at least one reserved time slot within the cycle for transmission of data belonging to the given path and wherein all transmissions of data belonging to the given path by a node in the given path are scheduled to occur during the same at least one reserved time slot of that node in each cycle.

3. A method for scheduling all transmissions in an ad hoc network containing multiple nodes, comprising the steps of:
(a) dividing time into cycles and setting the cycle time of all the nodes in the network to the same size;
(b) having the nodes agree upon the start of the cycle;
(c) establishing a path of nodes from a given source of the data to a given destination of the data; and
(d) determining via trial and error at least one reserved time slot within the cycle for each node in the path to transmit data belonging to the path and optimizing the reserved time slots in a distributed fashion to reduce the end-to-end delay experienced by each path,
wherein in each cycle, each node in the path is scheduled to transmit data belonging to the path during the same at least one reserved time slot of that node.

4. The method of claim 3, wherein in step (d) it is assumed that if a given time slot is busy, the previous and subsequent time slots are also busy and the time slots to transmit data are determined accordingly, with the proviso that this assumption is ignored when
i) the next hop is to the destination node or the current hop is from the source node; or
ii) the sender explicitly specifies in the packet header field when the sender received the data from the previous hop, in which case the receiver marks the time slot specified by the sender as busy.

5. The method of claim 3, wherein a node initiates protection of an owned slot in the event an unidentified nearby offending sender is sensed to have begun transmitting an offending transmission in a time slot that interferes with at least one of said node's owned time slots, the protection comprising:
a) said node sending a notice in the form of a header field in all transmissions for several cycles, wherein the header field indicates the approximate offset of the offending transmission;
b) neighboring nodes of said node propagating the notice among their neighboring nodes, thereby enabling the notice to spread outward through the areas where the offending sender may be located; and
c) the offending sender, upon receipt of the notice, removes from use any overlapping time slots.

6. The method of claim 3, wherein a destination node receives notice of whether the end-to-end delay of the current transmission schedule is satisfactory or unsatisfactory; and wherein the destination node and the intermediate nodes propagate this notice backward along the path and if the delay is unsatisfactory the intermediate nodes, in turn attempt to acquire new, earlier time slots that will result in a reduction of the end-to-end delay.

7. The method of claim 3, wherein the ad hoc network is a wireless, wired, acoustic or optical network.

8. The method of claim 7, wherein the ad hoc network is an RF wireless network with negligible propagation delays.

9. The method of claim 8, wherein the nodes agree upon the start of the cycle by having a sender node send each data packet with a packet header that includes the cycle time and the sender's offset so that the receiver node can compare the sender node's offset with the receiver node's offset and accordingly adjust the start of the next cycle so that the receiver node offset is the same as the sender node's offset.

10. The method of claim 8, wherein the trial and error determination of reserved time slots comprises the sender node attempting to win a reserved time slot of a given size and at a given offset by sending a data packet with the given size and the given offset to the next node in the path, wherein if the next node acknowledges the transmission was successful the sender node has reserved ownership of that time slot and if the transmission was not successful the sender node the sender node repeats the process until successful in reserving a time slot.

11. The method of claim 10, wherein each node keeps a list of time slots that the node has unsuccessfully attempted to use and avoids attempting to use the time slots on the list in the future.

12. The method of claim 7, wherein the ad hoc network is an acoustic network.

13. The method of claim 12, wherein the cycle is divided into an experimental section in which new, unapproved transmissions may be attempted and an established section, in which only approved transmissions may occur and wherein node ownership of a new time slot in the established section is obtained by said node:
a) sending a request packet to neighboring nodes during the experimental section with the request packet containing a delta value indicating the difference in time between the time the request packet was sent and time proposed by said node for the time slot in the established section; and
b) receiving approval from neighboring nodes.
